(19) United States
(12) Patent Application Publication
(10) Pub. No.: US 2015/0273804 A1
(43) Pub. Date: Oct. 1, 2015

(54) WOOD COMPOSITE PRODUCT

(71) Applicant: Li Haixing, Jiangsu Province (CN)

(72) Inventor: Li Haixing, Jiangsu Province (CN)

(73) Assignee: JIANGSU KENTIER WOOD CO., LTD., Danyang City (CN)

(21) Appl. No.: 14/487,690

(22) Filed: Sep. 16, 2014

Related U.S. Application Data
(63) Continuation-in-part of application No. 14/272,841, filed on May 8, 2014.

(30) Foreign Application Priority Data
Mar. 31, 2014 (CN) 201410122932.3

(51) Int. Cl. B32B 27/08; B32B 27/30; B32B 27/32; B32B 3/26

(52) U.S. Cl. CPC B32B 27/08; B32B 3/26; B32B 27/304; B32B 27/32; B32B 2250/02; B32B 2250/246; B32B 2264/062; B32B 2307/102; B32B 2264/104; B32B 2305/022; B32B 2270/00

(57) ABSTRACT

An method of forming a composite wood product including forming a top layer of a plastic material; forming a bottom layer of a composite material that is comprised of a combination of a plastic material and a straw material; and securing the top and bottom layers to form the composite wood product. With regard to the product a composite board product includes a top layer of a plastic material; a bottom layer of a composite material that is comprised of a combination of a plastic material and a straw material. The top and bottom layers are attached to form the composite wood product.

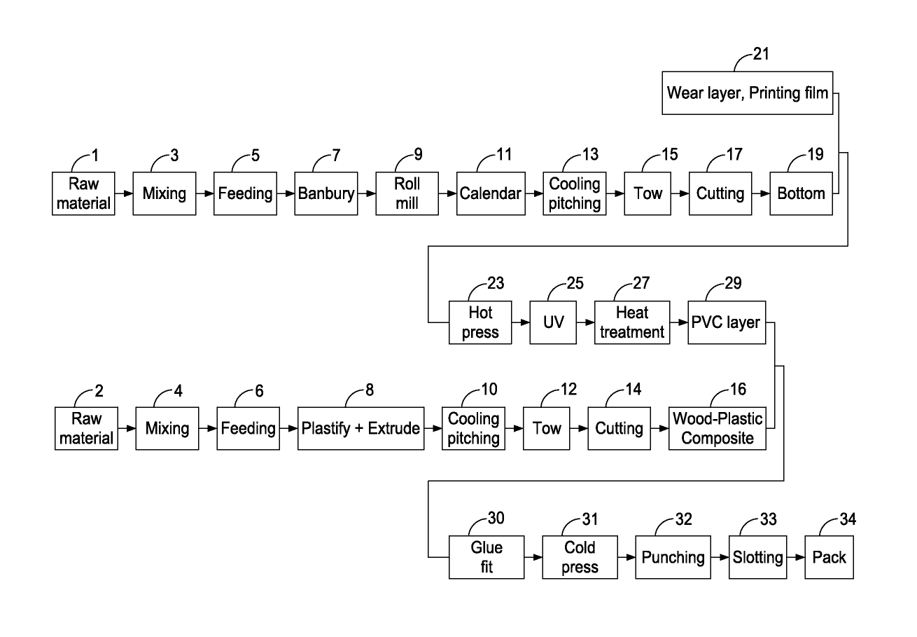

### RELATED CASES

This application is a continuation-in-part (CIP) of U.S. Ser. No. 14/272,841 filed on May 8, 2014 which claims priority to Chinese Application No. 201410122932.3 which was filed on Mar. 31, 2014 and each of which is incorporated by reference herein in its entirety.

### FIELD OF THE INVENTION

The present invention relates to a method of forming a composite wood product and the associated wood composite product that is manufactured by the method that is described.

### BACKGROUND OF THE INVENTION

Wood beams are generally cut from naturally growing trees. However, there certainly is a limit on the supply of trees due primarily to the substantially long time for a tree to reach maturity. Also, the supply of natural wood is limited by the deforestation that is now occurring in many parts of the world.

There are thus several alternate materials that have been developed to produce composite lumber products. For example, wood scraps, inferior quality lumber materials and even sawdust has been used in particular processes. This technique has been utilized to manufacture particle board from small wood particles and to manufacture plywood from wood veneer sheets.

One process that has been developed involves coating strands of wood with an adhesive and subjecting the material to heat and compression. One example of this is found in U.S. Pat. No. 4,061,819. Similar products are disclosed as manufactured from a bamboo material. Refer, for example to U.S. Pat. No. 5,543,197.

Another material that has been used for composite material is cork. In this regard, reference may also be made to U.S. Pat. No. 8,541,085 that shows a technique incorporating both bamboo and cork.

Although some of these techniques have been successful in replacing natural wood products, there is still a need for a substitute product that is less expensive and that is at least as equally strong as a natural wood material.

Accordingly, it is an object of the present invention to provide an improved wood composite product that can be manufactured less expensively and yet has sufficient strength and rigidity.

### SUMMARY OF THE INVENTION

To accomplish the foregoing and other objects, features and advantages of the present invention there is provided a method of forming a composite wood product comprising the steps of:

forming a top layer of a plastic material;

forming a bottom layer of a composite material that is comprised of a combination of a plastic material and a straw material; and

securing the top and bottom layers to form the composite wood product.

In accordance with other aspects of the present invention the step of forming a top layer of a plastic material includes mixing at least a PVC resin and a heat stabilizer; including an epoxy soybean oil and powder, and high speed mixing the epoxy soybean oil and powder with the PVC resin and heat stabilizer, after the temperature reaches 90-100 Celsius Degree, starting a cooling mixer, then unload the materials from high speed mixing into the cooling mixer, and at the same time, unload a pre-measured powder into the cooling mixer and mixing for 8-10 minutes; including providing a Banbury machine, unload a predetermined amount of materials into the Banbury mixing chamber, plasticizing for 8-10 minutes, then unload the materials into a feeding machine for directing to the roll mill; including feeding the material from the Banbury mixer into a roll mill for further plasticizing, keeping the temperature between 180-190 Celsius, wait until the material is equally plasticized on the roll mill, with substantially no visible powder, then it's ready to send to the Calender; including transporting the material to a calendar, adjust the roll spacing and speed, establishing the temperature of the roll to between 180-190 Celsius, further plasticize the material delivered to the Calender until the film reaches its uniformly desired thickness; wherein the step of forming a bottom layer of a composite material includes providing an extruder and setting the extruder to operate at on the order of 170 Celsius, melt-plasticize the material from the hopper of the extruder, and extrude through a mould to a vacuum pitching device; including vacuum pitching the material using a vacuum pitching device to provide cooling pitching with recycling cooling water; including providing a towing machine to tow out the wood-plastic composite from the cooling pitching device, and deliver to a cutting machine; and wherein the step of securing the layers includes a glueing step.

In accordance with the present invention there is also provided a composite board product comprising:

a top layer of a plastic material;

a bottom layer of a composite material that is comprised of a combination of a plastic material and a straw material;

said top and bottom layers attached to form the composite wood product.

In accordance with other aspects of the present invention the top layer is formed of a plastic material includes at least a PVC resin and a heat stabilizer; including an epoxy soybean oil and powder, and a high speed mixer for the epoxy soybean oil, powder, PVC resin and heat stabilizer, after the temperature reaches 90-100 Celsius Degree, and a cooling mixer, wherein the material is unloaded the materials from high speed mixer into the cooling mixer, and including a pre-measured powder disposed into the cooling mixer and mixing for 8-10 minutes; including a Banbury machine, unloading a predetermined amount of materials into the Banbury mixing chamber, plasticizing for 8-10 minutes, then unloading the material into a feeding machine for directing to a roll mill; wherein the material from the Banbury mixer is disposed into the roll mill for further plasticizing, keeping the temperature between 180-190 Celsius, wait until the material is equally plasticized on the roll mill, with substantially no visible powder, then it's ready to send to a calender; wherein the material is coupled to the calendar, the calendar is adjusted for roll spacing and speed, the temperature of the roll is between 180-190 Celsius, further plasticizing the material delivered to the calender until the film reaches its uniformly desired thickness; including an extruder operating at on the order of 170 Celsius to melt-plasticize the material from the hopper of the extruder, and a vacuum pitching device; including a vacuum pitching device for vacuum pitching the material to provide cooling pitching with recycling cooling water; including a towing machine to tow out the wood-plastic composite from the cooling pitching device, and a cutting machine; and wherein the layers are laminated.

In accordance with still other aspects of the present invention the top layer is formed of a plastic material including at least a PVC resin and a heat stabilizer; the top layer is also formed of an epoxy soybean oil and powder; the top layer also includes diisononyl phthatale; the heat stabilizer includes a Ca—Zn composite; the straw is selected from the group of dry stocks or stems of grain products including, but not limited to, wheat, rye, oats and barley; the straw is selected from the group of rice straw and grasses including sisal, flax, hemp, and other lignocelluloses; the bottom layer also includes a heat stabilizer; the bottom layer also includes a foaming agent; and the bottom layer also includes a lubricant agent.

One of the important considerations of the present invention is the use of a straw material that is fabricated into one layer in association with a second layer that is a plastic material. The straw material is considered to be comprised of dry stocks or stems of grain products including, but not limited to, wheat, rye, oats and barley. Other materials that are considered as falling within the parameters of the present invention include, but are not limited to, rice straw and grasses including sisal, flax, hemp, and other lignocelluloses.

### BRIEF DESCRIPTION OF THE DRAWINGS

It should be understood that the drawings are provided for the purpose of illustration only and are not intended to define the limits of the disclosure. In the drawings depicting the present invention, all dimensions are to scale. The foregoing and other objects and advantages of the embodiments described herein will become apparent with reference to the following detailed description when taken in conjunction with the accompanying drawings in which the sole diagram is a block diagram illustrating the steps in providing the wood composite material of the present invention.

### DETAILED DESCRIPTION

The present invention relates to an improvement in an engineered wood composite material that is durable, easy to manufacture and provides an effective wood appearing surface. The following are a series of steps that are used in performing the method of fabrication of the wood composite material of the present invention. In regard to the method disclosed herein refer to the sole FIGURE which is a block diagram illustrating the steps used in fabricating the engineered wood composite material of the present invention. Also, there is shown in Tables I and II herein a listing of preferred ingredients for each of the wood plastic composite layer and the PVC layer, respectively. Here are the Tables:

TABLE I

| Component | Quantity | Ratio | Specification of Component Function |
|---|---|---|---|
| PVC (Type 8) | 75 | 0.5389 | One of the main raw materials. It is the carrier used to bond |
| Polyvinyl Chlorid | | | wood powder and straw together, so the wood-plastic |
| SG-8 | | | composite has the characteristics of plastics. |
| Straw | 8 | 0.0576 | One of the main raw materials. It is made of plant fiber. It is |
| | | | green and environmental friendly. Materials are easily |
| | | | accessible and renewable (the pollution from Straw Burning |
| | | | could be effectively curbed). Actively Plasticization |
| | | | processing, and gives wood-plastic composite wood |
| | | | characteristics. It is generally considered to be the dry stalks or |
| | | | stems of grain products including, but not limited to, wheat, |
| | | | rye, oats and barley. Other materials that are considered as |
| | | | falling within the parameters of the present invention include, |
| | | | but are not limited to, rice straw and grasses including sisal, |
| | | | flax, hemp, and other lignocelluloses. |
| Light Calcium | 28 | 0.2015 | Main filler. It is used to strengthen the hardness of the wood- |
| Carbonate | | | plastic composite. |
| Ca—Zn Composite | 2.8 | 0.0202 | Heating stabilizer. Used to prevent PVC from thermal |
| Heat Stabilizer | | | degradation. |
| G60 Internal | 0.75 | 0.0054 | Internal lubricant. Used to adjust its mobility, to facilitate the |
| lubricant Agent | | | process. |
| PVC Internal | | | |
| Lubricant LG60 | | | |
| Forming Agent 90 | 6 | 0.0432 | Adjusting the foaming of the foaming agent. Promotes the |
| PVC Acrylic Resins | | | plasticization of the PVC, improves the strength of the PVC |
| Foaming Agent LP- | | | melting. Prevents bubbles from merging or bursting. |
| 90 | | | |
| JM01 | 4 | 0.0288 | Strengthening agent. Strengthens the hardness of the product. |
| PEVax | 0.35 | 0.0025 | External Lubricant. Makes product easier to be extruded. |
| Tissuemat E | | | Improves processing efficiency. |
| AC Forming Agent | 0.45 | 0.0032 | Foaming agent. For foaming. |
| Azodi Carbonamide | | | |
| Foaming Agent | | | |
| CPE | 3 | 0.0216 | Toughening Agent. Improves the toughness of the product. |
| Chlorinated | | | |
| Polyethylene | | | |
| Sodium Bicarbonate | 0.6 | 0.0043 | Foaming agent. For foaming. |

Table I above sets forth details of the ingredients used in forming the wood-plastic composite material. A summary of these materials is set forth

TABLE II

| Component | Quantity | Ratio | Specification of Component Function |
|---|---|---|---|
| PVC resin | 150 kg | 30.71% | One of the main raw materials. |
| Powder | 300 kg | 61.41% | One of the main raw materials. |
| DINP | 30 kg | 6.14% | Diisononyl phthalate (DINP) is a phthalate used as a |
| | | | plasticizer. Diisononyl phthalate (DINP) is a member of |
| | | | the group of esters commonly known as phthalates1. |
| Epoxy Soybean Oil | 5.0 kg | 1.02% | Main filler. Epoxidized soybean oil, better known by its |
| | | | acronym, ESBO, is a plasticizer used in polyvinyl chloride (PVC) |
| | | | plastics. |
| Ca—Zn Composite | 3.5 kg | 0.70% | Heating stabilizer. Used to prevent PVC from thermal |
| Heat Stabilizer | | | degradation. |

In the following descriptions each step is identified by a reference number and the following is a list of reference numbers with associated descriptions related to each reference number and associated method step. For the most part each of the steps that are set forth is performed by known equipment as will be identified herein.

Wood-plastic composite layer
2. Raw material (refer to Table I)
Prepare raw material-PVC Resin, Wood Powder, Straw, Light Calcium Carbonates, Ca—Zn Composite Heat Stabilizer, PVC Internal Lubricant LG60, PVC Acrylic Resins Foaming Agent LP-90, JM01, Tissuemat E, Azodi Carbon amide AC Foaming Agent, CPE (Chlorinated Polyethylene), Sodium Bicarbonate. Table I identifies the main ingredients and ratios of these respective ingredients.
   4. Mixing (Device used: high speed mixing machine)
(1) According to the requirement of the formula, manually measure the ratio of the formula with precise precision
(2) After measurement, start the High-speed Mixing Machine, unload the pre-measured materials into the high-speed mixer, and mix about 15 minutes.
   6. Feeding (Device used: feeding machine)
Unload the well mixed material into the hopper of the extruding machine through the automatic screw feeding machine
   8. Extruding Plasticizing (Device used: Twin Screw Extruder)
Pre-set the extruder and keep its temperature at around 170 Celsius. Melt-plasticize the material from the hopper of the extruder, and extrude through a mould to a vacuum pitching device.
   10. Cooling Pitching (Device used: Vacuum Pitching Device)
Extrude material from a mould of the Extruder to a vacuumed pitching device, cooling pitching with recycling cooling water.
   12. Tow (Device used: Towing machine)
Tow out the wood-plastic composite from the cooling pitching device with the towing machine, and deliver to a cutting machine.
   14. Cutting (Device used: Cutting machine)
Cut the wood-plastic composite into desired length. Neatly stack the cut wood-plastic composites into a tray. The height of the stack should be no higher than 1 m.
   16. Wood-plastic composite layer (final composite layer)
This box or step represents one of the layers that is to be joined in providing the final composite product. Refer to later steps 29 and 30.
   PVC layer

### 1. Raw Material

Prepare raw material—PVC Resin, Powder, DINP, Epoxy Soybean Oil, Small Raw Material (Ca—Zn Composite Heat stabilizer).
   3. Mixing (Device used: High-speed mixing machine, Low-speed mixing machine)
(1) According to requirement of the formula, manually measure the ratio of the formula with precise precision.
(2) After measurement, Start High-speed Mixing Machine, unload the pre-measured PVC Resin, DINP, Epoxy Soybean Oil, and small material (Ca—Zn Composite Heat stabilizer) into the High-speed Mixing Machine. After the temperature reaches 90-100 Celsius Degree, start the cooling mixer, then unload the materials from High-speed Mixer into the Cooling mixer, and at the same time, unload the pre-measured powder into the cooling mixer and mix for 8-10 minutes.
(3) Unload the materials from the cooling mixer into a storage container for later use.
   5. Feeding (Device used: digital measuring scale)
Unload the materials from the mixer storage container into a Banbury Mixer after measurement.
   7. Banbury (Device used: Banbury Machine)
Unload about 120 kg of materials into the Banbury Mixing chamber, plasticizing for 8-10 minutes, then unload the materials into a feeding machine for directing to the roll mill.
   9. Roll Mill (Device used: Roll Mill)
The feeding machine feeds the post-banbury materials into a roll mill for further plasticizing, keeping the temperature between 180-190 Celsius. Wait until the material is equally plasticized on the roll mill, with no visible powder, then it's ready to send to the Calender.
   11. Calender (Device used: Four-Roll Calender)
Adjust the roll spacing and speed. The temperature of the roll should be kept between 180-190 Celsius, further plasticize the material delivered to the Calender until the film reaches its uniformly desired thickness.
   13. Cooling Pitching (Device used: Nine-Roll Cooler)
Fill recycling cooling water into the Cooling Rolls, cooling pitching the films from the Calender.
   15. Tow (Device used: Towing Machine)
Tow the cooled film with the towing machine, and deliver to a cutting machine.
   17. Cutting (Device used: Cutting machine)
Cut the towed film at cutting machine into desired length, stack the cut films neatly on a tray not higher than 1 m.

### 19. Bottom

After the step 17, the semi-finished products are called bottoms.
   21. Wear Layer, Printing film
Wear Layer: PVC Resin (no powder added) rolling into transparent, abrasion-resistant surface.
Printing film: Printing film. The texture and color on the surface of the floor.
   23. Hot Press (Device used: Hot pressed molding machine)
(1) Prepare materials. Prepare all the bottoms, printing films and wear layers for hot press. All surfaces are to be flawless and smooth.
(2) Laminating the material. When laminating, try to lay every layer in the middle of the tray and align each layer. Do not stagger or miss any layers. Do not mix with foreign object. Do no wrinkle the printing film. There is a need to align the pattern, so do not misplace the pattern.
(3) Put all layers into pressing machine for the hot press step. Keep temperature between 120-140 Celsius for about 20 minutes with pressure around 5 mpa. After hot pressing, put into cooling water for cooling. Raise pressure to around 15 mpa for about 20-25 minutes. Unload the floor from the hot press machine when its temperature reaches around 45 Celsius.
(4) Take out the pressed floor, neatly place them on a tray. Leave them there for at least 24 hours for further processing.
   25. UV (Device used: UV machine)
1. Before pouring, UV paint is mixed for at least 2 hours. When pouring with UV paint, the bucket should be filled up at once. Preferably do not fill repeatedly after the machine is turned on. After the machine turns off, pour UV paint into the corresponding UV bucket.
2. Adjust the height of the roll, put in the “floor”. When putting in the floor, make sure all floors are in the same direction (as the arrow indicates). Keep the surface of the rubber roll clean and undamaged.
   27. Heat Treatment (Device used: Heat treatment water sink)
Put the floor into heating a treatment process device right after the UV step to eliminate the internal stress of the floor. Keep the temperature of the hot water around 70 Celsius, and the cold water around 25 Celsius during the heating treatment. After heating treatment, leave the floor to stand for a while.
   30. Glue Fit (Device used: Glue Fitting Machine)
(1) Use glue fitting machine to apply the glue evenly onto the surface of the Wood-Plastic Composite layer (box or step 16).
(2) Put PVC layer (box or step 29) into the feeding cannel of the glue fitting machine. Laminate the PVC layer with the pre-glued wood-plastic composite layer through the roller.
   31. Cold Press (Device used: Hot pressing shaping machine)
Stack the PVC laminated wood-plastic composite neatly on a tray. Push it into the pressing machine for cold pressing. The pressure should be around 2.0 mpa. Time of pressing should be around 30 minutes. Unload after cold pressing.
   32. Punching (Device used: Multilateral Saw)
Put big pieces of laminate into the punch after cold pressing. Punch into the desired smaller sizes.
   33. Slotting (Device used: Haomai Slotting Machine)
Slot the smaller sizes of the PVC wood-plastic from the punch into pre-formed PVC wood-plastic finished product.

### 34. Packaging

According to requests of the client, pack PVC wood-plastic finished product into packing boxes.

For the above procedures there have been found to be certain steps that are important to the proper operation of the method of the present invention, and to produce the desired product. Thus, the follow description provides some further details of these steps and materials along with the associated equipment that is used. This includes such steps and equipment as:

### 7. Banbury

Device used: Banbury Machine
Banbury Machine has a pair of two rotors in specific shape that move in opposite directions, which are used to plasticize and to mix polyester material with adjustable temperature and pressure within a closed compartment intermittently. The machine mainly includes a Banbury Compartment, rotors, rotors sealing device, feeding and pressing device, unloading device, transmission device, the base etc.

### 8. Extruding Plasticizing

Device used: A cone shaped twin screw extruder, preferably with 5 heating sections.
After putting material into the extruder via the hopper, through heating, the temperature rises, and at the same time rotate the screw and continuously cutting and plasticizing the material, so the material could fully melt and flow. Extrude from the mould to form into the desired shape.

### 9. Roll Mill

Device used: Roll Milling Machine
The main operating parts are two horizontal hollow or drilling rolls rotating in opposite directions inward. The roller on the side of the operator is called the front roller. It can be adjusted back and forth on the same horizontal level either manually or electronically to adjust the gap between the rollers according to the requirement of the operation. The back roller is fixed and not adjustable. The two rollers are normally identical and rotate in different speeds toward each other. Rubber or rubber compound is fed in between the two rollers as they rotated, experiences intense shear force in order to plasticize and mix. The Roll Milling Machine can also be used in plastics processing and other processing; mostly to further plasticize the material after the Banbury mixing.

### 10. Cooling Pitching

Device used: Vacuum Pitching Device
Extrude pre-formed material from the mould to a pitching board, which is made from stainless steel filled with recycling cooling water inside, cooling the material passing through the mould to keep the pre-shaped form.

### 11. Calendar

Device used: Four Rolls Calendar
A Calendar is a machine that includes two or more rollers, which are lined up strategically, and operates under a certain temperature. It is used to press and form the rubber and plastic material into a certain thickness and shape of films. The calendar preferably is a Four Rolls Calendar.

In accordance with another embodiment of the present invention a sound absorbing and attenuating layer may also be used in the structure that is formed. This may be a foam pad layer that is essentially disposed under the bottom or composite layer. In the sole drawing this may be represented by a further step, not shown in the drawing, of the fabrication of such a foam sound absorbing layer and its introduction at step 30 so that the step 31 of cold pressing also involves the gluing and pressing of this third sound absorbing layer, along with the other two layers.

Having now described a limited number of embodiments of the present invention, it should now be apparent to those skilled in the art that numerous other embodiments and modifications thereof are contemplated as falling within the scope of the present invention, as defined by the appended claims.

What is claimed is:

1-18. (canceled)

19. A method of forming a composite wood product comprising the steps of:
forming a bottom layer of a plastic material;
forming a top layer of a composite material that is comprised of a combination of a plastic material and a straw material;
securing the bottom and top layers to form the composite wood product.

20. The method of claim 19 wherein the step of forming a bottom layer of a plastic material includes mixing at least a PVC resin and a heat stabilizer.

21. The method of claim 20 also including an epoxy soybean oil and powder, and high speed mixing the epoxy soybean oil and powder with the PVC resin and heat stabilizer, after the temperature reaches 90-100 Celsius Degree, starting a cooling mixer, then unload the materials from high speed mixing into the cooling mixer, and at the same time, unload a pre-measured powder into the cooling mixer and mixing for 8-10 minutes.

22. The method of claim 20 further including providing a Banbury machine, unload a predetermined amount of materials into the Banbury mixing chamber, plasticizing for 8-10 minutes, then unload the materials into a feeding machine for directing to the roll mill.

23. The method of claim 22 including feeding the material from the Banbury mixer into a roll mill for further plasticizing, keeping the temperature between 180-190 Celsius, wait until the material is equally plasticized on the roll mill, with substantially no visible powder, then it's ready to send to the Calender.

24. The method of claim 23 including transporting the material to a calendar, adjust the roll spacing and speed, establishing the temperature of the roll to between 180-190 Celsius, further plasticize the material delivered to the Calender until the film reaches its uniformly desired thickness.

25. The method of claim 19 wherein the step of forming a top layer of a composite material includes providing an extruder and setting the extruder to operate at on the order of 170 Celsius, melt-plasticize the material from the hopper of the extruder, and extrude through a mould to a vacuum pitching device.

26. The method of claim 25 including vacuum pitching the material using a vacuum pitching device to provide cooling pitching with recycling cooling water.

27. The method of claim 26 including providing a towing machine to tow out the wood-plastic composite from the cooling pitching device, and deliver to a cutting machine.

28. The method of claim 19 wherein the step of securing the layers includes a glueing step.
